(19) United States
(12) Patent Application Publication
(10) Pub. No.: US 2019/0114406 A1
(43) Pub. Date: Apr. 18, 2019

(54) BIOMETRIC RECOGNITION LOCK SET AND MATCHING METHOD THEREOF

(71) Applicants: Hsin-Chung CHEN, Taipei City (TW); Image Match Design Inc., Zhubei City (TW)

(72) Inventor: Hsin-Chung CHEN, Taipei City (TW)

(21) Appl. No.: 16/158,891

(22) Filed: Oct. 12, 2018

(30) Foreign Application Priority Data
Oct. 13, 2017 (TW) 106135169

(51) Int. Cl. G06F 21/32; H04W 12/06; E05B 47/00

(52) U.S. Cl. CPC G06F 21/32; E05B 47/00; H04W 12/06

(57) ABSTRACT

A biometric recognition lock set includes a biometric recognition lock and a key, each of which stores a password. To unlock the biometric recognition lock, the key transmits the password it stored to the biometric recognition lock, and the biometric recognition lock will be unlocked responsive to matching of the password it received to the password stored in the biometric recognition lock.

### CROSS-REFERENCE TO RELATED APPLICATIONS

This application claims the priority benefit of Taiwan Application No. 106135169, filed 13 Oct. 2017, the contents of which in its entirety are herein incorporated by reference.

### FIELD OF THE INVENTION

The present invention relates to a lock set and, more particularly, to a biometric recognition lock set and a matching method thereof.

### BACKGROUND OF THE INVENTION

Conventional biometric recognition locks each have a sensing unit for sensing users' biological information, for example, biological information related to fingerprints, hand geometry, palm prints, retina, iris patterns, voice patterns, and vein patterns. The sensing units discern the users' biological information in order to recognize the users. A positive recognition result prompts the unlocking of the biometric recognition locks. The biometric recognition locks may be unlocked only if the sensing units sense the users' biological information; hence, the biometric recognition locks cannot be unlocked, if the sensing units malfunction.

In an attempt to overcome the aforesaid drawback of the prior art, the conventional biometric recognition locks each come with a keyboard. In case the sensing unit malfunctions, a user can enter a password with the keyboard, so as to unlock the biometric recognition lock. However, it is difficult for the keyboard to be mounted on a small biometric recognition lock, such as a biometric recognition padlock and a biometric recognition chest lock. As a result, the small biometric recognition lock cannot be unlocked, if the sensing unit malfunctions. At present, there is no solution to the aforesaid drawbacks of the prior art, and in consequence the conventional biometric recognition locks lack ease of use.

Therefore, it is desired a biometric recognition lock set and a matching method thereof, which manifest ease of use.

### BRIEF SUMMARY OF THE INVENTION

It is an objective of the present invention to provide a biometric recognition lock set and a matching method thereof, which manifest ease of use.

Another objective of the present invention is to provide a biometric recognition lock set comprising a biometric recognition lock and a key, and a matching method thereof.

According to the present invention, a biometric recognition lock set comprises a biometric recognition lock having a first password and a key having a second password. Upon transmission of the second password from the key to the biometric recognition lock and determination that the second password matches the first password, the biometric recognition lock is unlocked.

According to the present invention, a matching method for a biometric recognition lock set comprising a biometric recognition lock and a key comprises generating a password and storing the password in the biometric recognition lock and the key to allow the key to transmit the password to the biometric recognition lock, so as to unlock the biometric recognition lock.

The biometric recognition lock set of the present invention comprises a biometric recognition lock and a key. Identical passwords are stored in the biometric recognition lock and the key so that the biometric recognition lock and the key match. Therefore, the key transmits its password to the biometric recognition lock, so as to unlock the biometric recognition lock. Therefore, given the key, the biometric recognition lock can be unlocked whenever a sensing unit malfunctions, thereby enhancing ease of use.

### BRIEF DESCRIPTION OF THE SEVERAL VIEWS OF THE DRAWINGS

FIG. 1 is a schematic view of a biometric recognition lock set according to the present invention;

FIG. 2 shows the biometric recognition lock set according to the first embodiment of the present invention;

FIG. 3 is a perspective schematic view of the biometric recognition lock set according to the first embodiment of the present invention;

FIG. 4 is a perspective schematic view of the biometric recognition lock set according to the first embodiment of the present invention;

FIG. 5 shows the biometric recognition lock set according to the second embodiment of the present invention;

FIG. 6 is a perspective schematic view of the biometric recognition lock set according to the second embodiment of the present invention;

FIG. 7 is a perspective schematic view of the biometric recognition lock set according to the second embodiment of the present invention;

FIG. 8 is a perspective schematic view of a key of the biometric recognition lock set according to the second embodiment of the present invention;

FIG. 9 is a flowchart of a matching method for the biometric recognition lock set according to the present invention;

FIG. 10 is a flowchart of a matching method for the biometric recognition lock set according to the present invention; and

FIG. 11 is a flowchart of a matching method for the biometric recognition lock set according to the present invention.

### DETAILED DESCRIPTION OF THE INVENTION

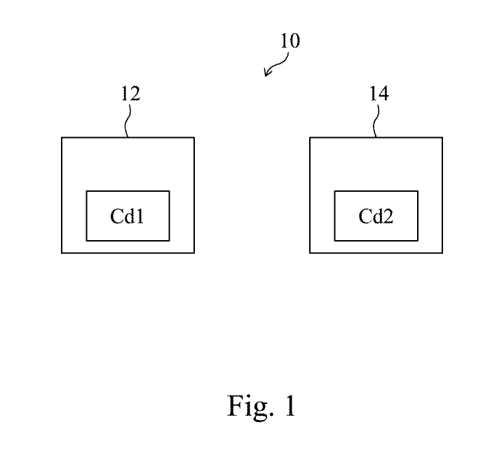

Referring to FIG. 1, a biometric recognition lock set 10 of the present invention comprises a biometric recognition lock 12 and a key 14. The biometric recognition lock 12 has a password Cd1. The key 14 has a password Cd2. Upon transmission of the password Cd2 from the key 14 to the biometric recognition lock 12 and determination that the password Cd2 matches the password Cd1, the biometric recognition lock 12 is unlocked.

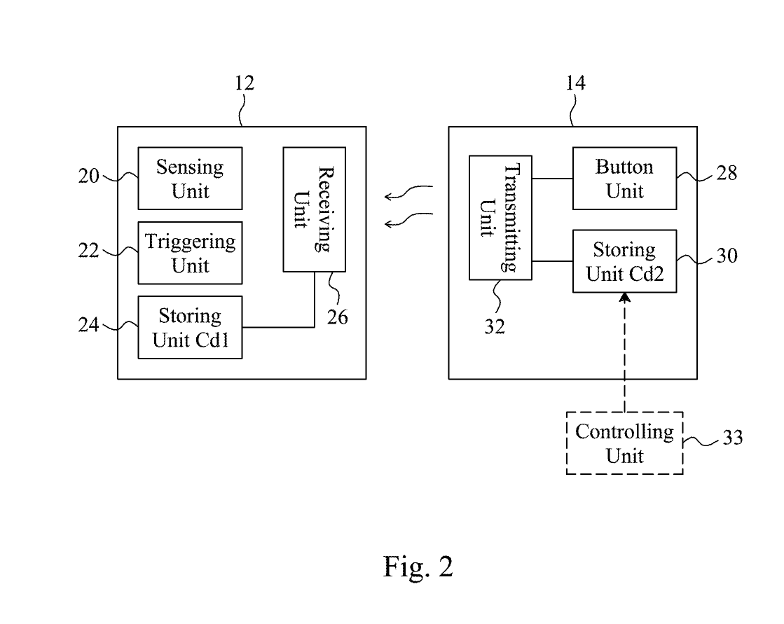

FIG. 2 shows the biometric recognition lock set 10 according to the first embodiment of the present invention. The key 14 comprises a button unit 28, a storing unit 30 and a transmitting unit 32. The storing unit 30 stores the password Cd2. The transmitting unit 32 is connected to the button unit 28 and the storing unit 30 and adapted to transmit the password Cd2 to the biometric recognition lock 12 as soon as the button unit 28 is pressed. The password Cd2 comprises a random number composed of 8-16 digits and generated by a controlling unit 33. The biometric recognition lock 12 comprises a sensing unit 20, a triggering unit 22, a receiving unit 26 and a storing unit 24. The sensing unit 20 senses a user's biological information, for example, biological information related to fingerprints, hand geometry, palm prints, retina, iris patterns, voice patterns, and vein patterns, so as to unlock the biometric recognition lock 12. Afterward, the triggering unit 22 triggers the biometric recognition lock 12 to enter a configuration state. The receiving unit 26 receives the password Cd2 transmitted by the transmitting unit 32 of the key 14. The storing unit 24 is connected to the receiving unit 26 to store the password Cd2 transmitted from the key 14 as the password Cd1 when the biometric recognition lock 12 is in the configuration state. The storing unit 24 of the biometric recognition lock 12 stores the password Cd2 as the password Cd1, and then the configuration state is ended.

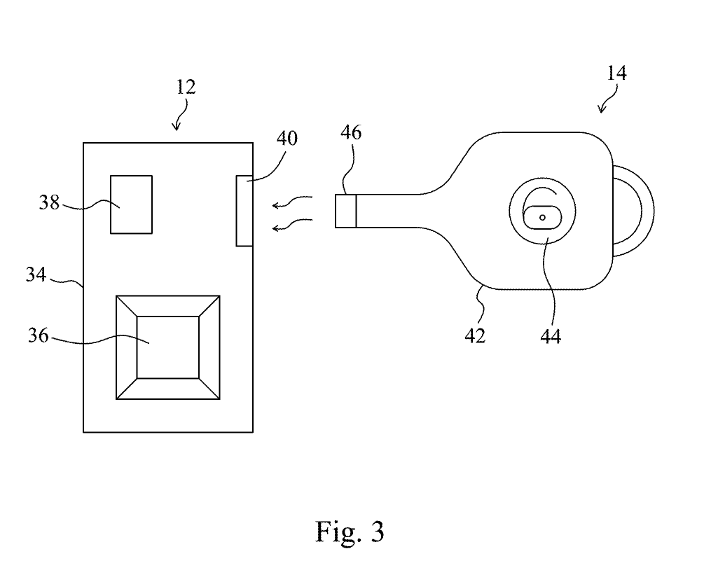

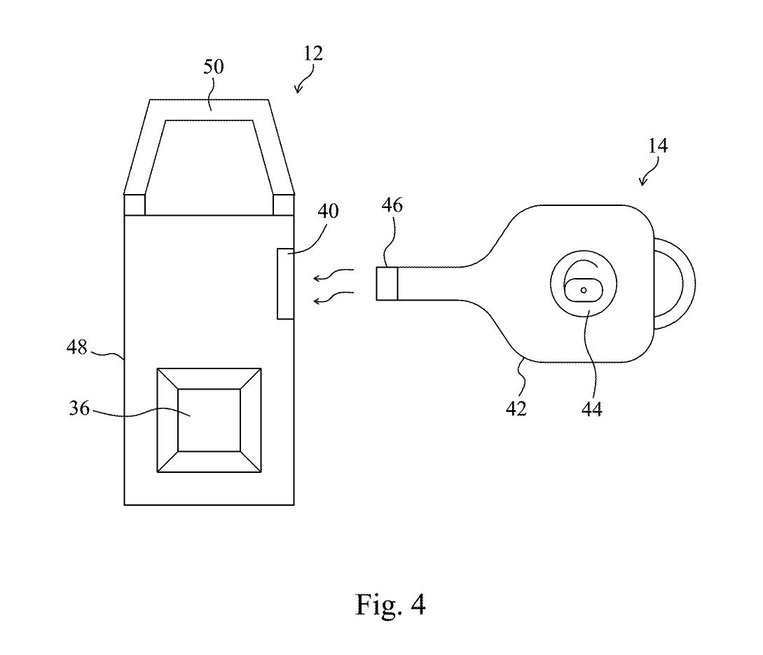

FIG. 3 is a perspective schematic view of the biometric recognition lock 12 and the key 14 of the biometric recognition lock set 10 according to the first embodiment of the present invention. Referring to FIGS. 2, 3, the key 14 has a body 42. The button unit 28 comprising a button 44 is disposed on the surface of the body 42. The transmitting unit 32 comprising an infrared emitter 46 is disposed on the surface of the body 42. The user presses the button 44 so that the password Cd2 stored in the storing unit 30 inside the body 42 is transmitted to the biometric recognition lock 12 by infrared. The biometric recognition lock 12 comprises a fingerprint recognition lock with a body 34. The sensing unit 20 comprising a fingerprint sensor 36 is disposed on the surface of the body 34. The sensing unit 20 senses the user's fingerprints, thereby allowing the biometric recognition lock 12 to be unlocked. The triggering unit 22 comprising a button 38 is disposed on the surface of the body 34. The user presses the button 38 continuously for a predetermined time period (for example, three seconds) to trigger the biometric recognition lock 12 to enter the configuration state. The receiving unit 26 comprising an infrared emitter 40 is disposed on the surface of the body 34 to receive the password Cd2 transmitted from the key 14 by the infrared emitter 46. Preferably, as shown in FIG. 4, the biometric recognition lock 12 comprises a biometric recognition padlock with a hook 50, for example, a fingerprint recognition padlock with the hook 50. Referring to FIGS. 2, 4, the hook 50 is disposed on the surface of the body 48. The sensing unit 20 comprising the fingerprint sensor 36 is disposed on the surface of the body 48. The sensing unit 20 senses the user's fingerprints, thereby allowing the biometric recognition lock 12 to be unlocked. The triggering unit 22 comprises the hook 50. When the hook 50 is at a locked position (that is, when the biometric recognition lock 12 is locked), the user presses the hook 50 continuously for a predetermined time period (for example, three seconds) to trigger the biometric recognition lock 12 to enter the configuration state. The receiving unit 26 comprising the infrared emitter 40 is disposed on the surface of the body 48 to receive the password Cd2 transmitted by the infrared emitter 46.

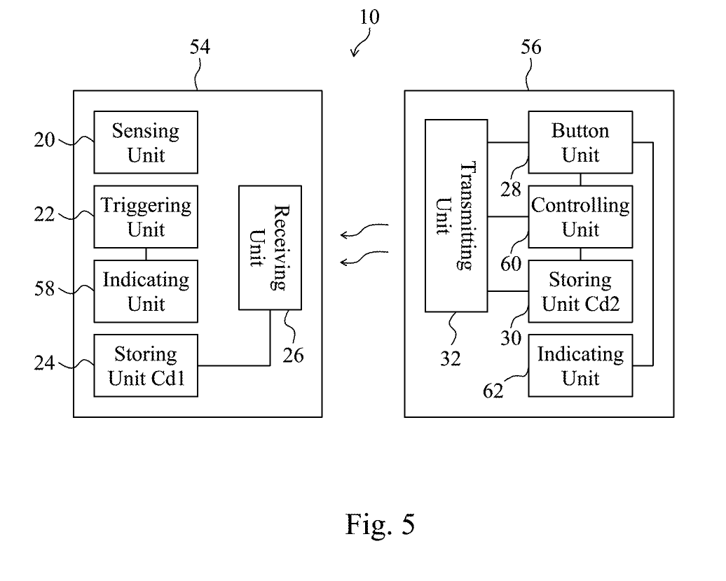

FIG. 5 shows the biometric recognition lock set 10 according to the second embodiment of the present invention. In the second embodiment, the biometric recognition lock set 10 comprises a biometric recognition lock 54 and a key 56. The key 56 comprises the button unit 28, the storing unit 30, the transmitting unit 32, a controlling unit 60 and an indicating unit 62. The button unit 28, the storing unit 30 and the transmitting unit 32 are depicted in FIG. 2 and thus, for the sake of brevity, are not described herein. The controlling unit 60 is connected to the button unit 28 and the storing unit 30. After the user has pressed the button unit 28 continuously for a first predetermined time period, the controlling unit 60 generates and transmits the password Cd2 to the storing unit 30 for storage. The indicating unit 62 is connected to the button unit 28 to generate a first indicative signal in response to the generation of the password Cd2 by the controlling unit 60. After the transmitting unit 32 has transmitted the password Cd2 to the biometric recognition lock 54, the first indicative signal ends. The password Cd2 comprises a random number composed of 8-16 digits. The biometric recognition lock 54 comprises the sensing unit 20, the triggering unit 22, the receiving unit 26, the storing unit 24 and an indicating unit 58. The sensing unit 20, the triggering unit 22, the receiving unit 26 and the storing unit 24 are depicted in FIG. 2 and thus, for the sake of brevity, are not described herein. The indicating unit 58 is connected to the triggering unit 22 to generate a second indicative signal as soon as the triggering unit 22 triggers the biometric recognition lock 54 to enter the configuration state. The indicating unit 58 stops generating the second indicative signal as soon as the configuration state of the biometric recognition lock 54 ends.

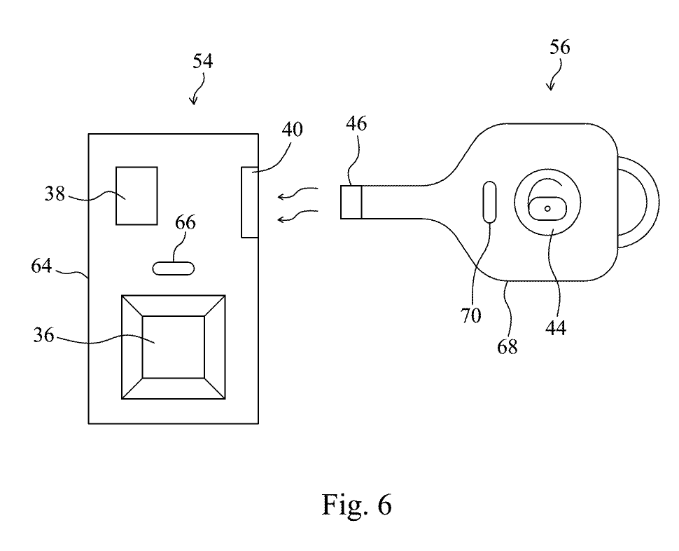

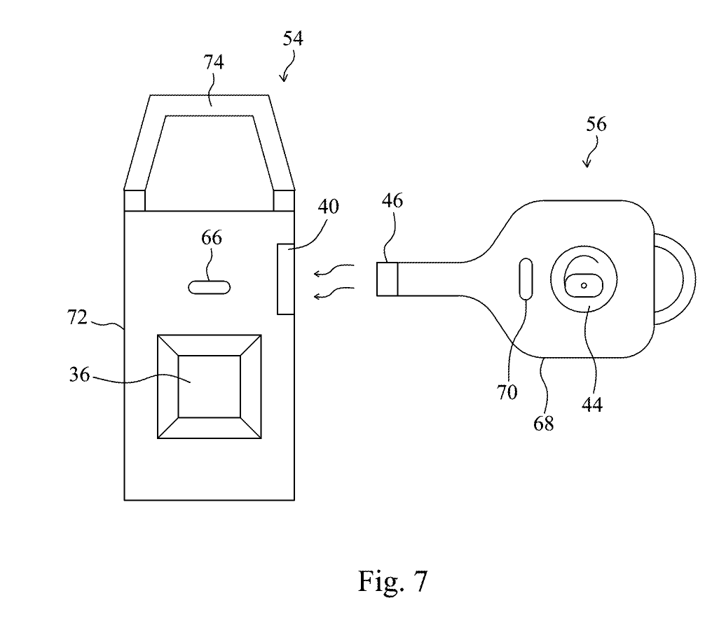

FIG. 6 is a perspective schematic view of the biometric recognition lock 54 and the key 56 of the biometric recognition lock set 10 according to the second embodiment of the present invention. Referring to FIGS. 5, 6, the key 56 has a body 68. The button unit 28 comprising the button 44 is disposed on the surface of the body 68. The user presses the button 44 continuously for the first predetermined time period to trigger the controlling unit 60 inside the body 68 to generate and transmit the password Cd2 to the storing unit 30 inside the body 68 for storage. The transmitting unit 32 comprising the infrared emitter 46 is disposed on the surface of the body 68. The user presses the button 44 once to trigger the infrared emitter 46 to transmit the password Cd2 to the biometric recognition lock 54 by infrared. The indicating unit 62 comprising an indicator lamp 70 is disposed on the surface of the body 68. In response to the generation of the password Cd2 by the controlling unit 60, the indicating unit 62 generates a first indicative signal, for example, a light signal generated from the indicator lamp 70 and flashing at a first frequency. After the transmitting unit 32 has transmitted the password Cd2 to the biometric recognition lock 54, the indicating unit 62 stops generating the first indicative signal, for example, the indicator lamp 70 turns off. The biometric recognition lock 54 comprises a fingerprint recognition lock having a body 64. The sensing unit 20 comprising the fingerprint sensor 36 is disposed on the surface of the body 64 to sense the user's fingerprints, so as to unlock the biometric recognition lock 54. The triggering unit 22 comprising the button 38 is disposed on the surface of the body 64. The user presses the button 38 continuously for a second predetermined time period (for example, three seconds) to trigger the biometric recognition lock 54 to enter the configuration state. The receiving unit 26 comprising the infrared emitter 40 is disposed on the surface of the body 64 to receive the password Cd2 transmitted by the infrared emitter 46 of the key 56. The indicating unit 58 comprising an indicator lamp 66 is disposed on the surface of the body 64 to generate, as soon as the biometric recognition lock 54 enters the configuration state, a second indicative signal, for example, a light signal generated from the indicator lamp 66 and flashing at a second frequency, and stop generating the indicative signal, for example, the indicator lamp 66 turns off, as soon as the configuration state ends. Preferably, as shown in FIG. 7, the biometric recognition lock 54 comprises a biometric recognition padlock with a hook 74, for example, a fingerprint recognition padlock with the hook 74. Referring to FIGS. 5, 7, the hook 74 is disposed on the surface of a body 72. The sensing unit 20 comprising the fingerprint sensor 36 is disposed on the surface of the body 72 to sense the user's fingerprints, so as to unlock the biometric recognition lock 54. The triggering unit 22 comprises the hook 74. When the hook 74 is at a locked position (that is, when the biometric recognition lock 54 is locked), the user presses the hook 74 continuously for a second predetermined time period (for example, three seconds) to trigger the biometric recognition lock 54 to enter the configuration state. The receiving unit 26 comprising the infrared emitter 40 is disposed on the surface of the body 72 to receive the password Cd2 transmitted by the infrared emitter 46. The indicating unit 58 comprising the indicator lamp 66 is disposed on the surface of the body 72 to generate a second indicative signal, for example, a light signal generated from the indicator lamp 66 and flashing at a second frequency, as soon as the biometric recognition lock 54 enters the configuration state, and stop generating the second indicative signal, for example, the indicator lamp 66 turns off, as soon as the configuration state ends. Preferably, the second frequency is different from the first frequency.

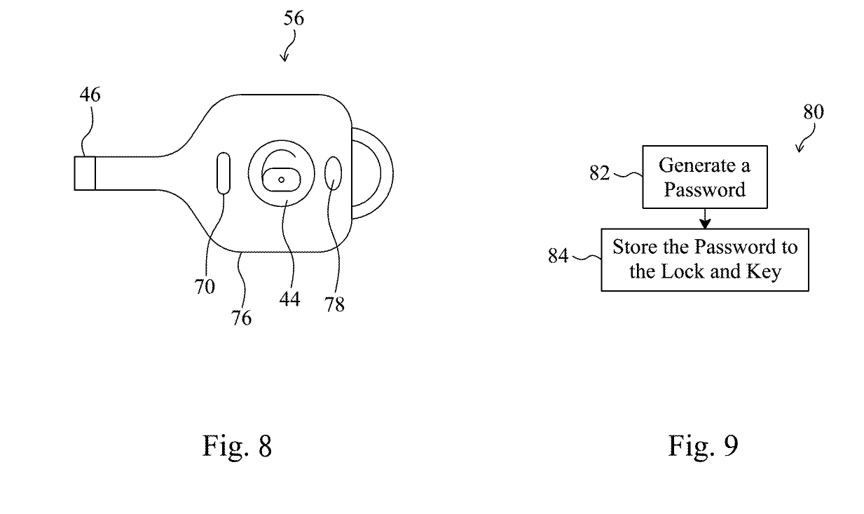

FIG. 8 is a perspective schematic view of the key 56 of the biometric recognition lock set 10 according to the second embodiment of the present invention. Referring to FIGS. 5, 8, the key 56 has a body. The button unit 28 comprising the button 44 and a button 78 is disposed on the surface of the body. The user presses the button 78 in order to trigger the controlling unit 60 inside the body to generate and transmit the password Cd2 to the storing unit 30 inside the body for storage. The transmitting unit 32 comprising the infrared emitter 46 is disposed on the surface of the body. The user presses the button 44 once to trigger the infrared emitter 46 to transmit the password Cd2 to the biometric recognition lock 54 by infrared. The indicating unit 62 comprising the indicator lamp 70 is disposed on the surface of the body to generate an indicative signal, for example, a light signal generated from the indicator lamp 70 and flashing at a frequency, in response to the generation of the password Cd2 by the controlling unit 60, and stop generating the indicative signal, for example, the indicator lamp 70 turns off, upon transmission of the password Cd2 to the biometric recognition lock 54 by the transmitting unit 32.

In a variant embodiment, the biometric recognition lock 12 shown in FIGS. 2-4 and the key 56 shown in FIGS. 5-8 together form different biometric recognition lock sets, whereas the biometric recognition lock 54 shown in FIGS. 5-7 and the key 14 shown in FIGS. 2-4 together form different biometric recognition lock sets.

FIG. 9 is a flowchart of a matching method for the biometric recognition lock set 10 according to the present invention. Referring to FIGS. 2, 5 and 9, step 82 involves generating a password, for example, the password Cd2, and this step comprises generating the password by the controlling unit 33 shown in FIG. 2, for example, generating a random number composed of 8-16 digits by the controlling unit 33, or triggering the key 56 of FIG. 5 to generate the password, for example, pressing the button unit 28 to trigger the controlling unit 60 in the key 56 to generate a random number composed of 8-16 digits. In an embodiment, the user presses the button unit 28 (for example, the button 44 shown in FIGS. 6, 7) continuously for a predetermined time period to trigger the controlling unit 60 to generate the password. In another embodiment, the user presses the button unit 28 (for example, the button 78 shown in FIG. 8) to trigger the controlling unit 60 to generate the password. Step 84 involves storing the password in the biometric recognition lock 12/54 and the key 14/56 to allow the password to be transmitted from the key 14/56 to the biometric recognition lock 12/54, so as to unlock the biometric recognition lock 12/54.

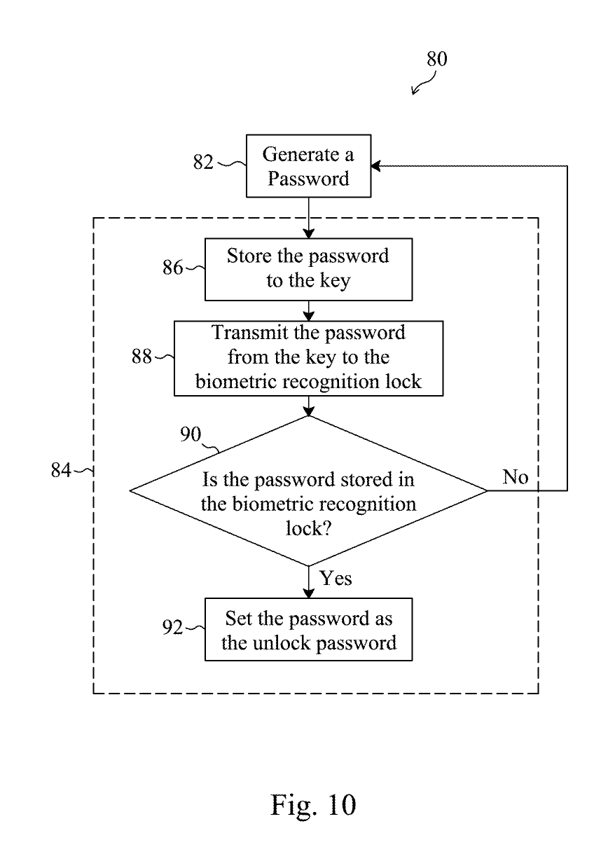

In an embodiment, as shown in FIG. 10, step 84 in 80 in the flowchart of FIG. 9 comprises step 86 through step 92. Referring to FIGS. 2, 5 and 10, step 86 involves storing the password in the key 14/56, for example, storing the password in the storing unit 30 of the key 14/56. Step 88 involves transmitting the password from the key 14/56 to the biometric recognition lock 12/54, for example, pressing the button unit 28 of the key 14/56 to trigger the transmitting unit 32 to transmit the password to the biometric recognition lock 12/54. Preferably, the transmitting unit 32 transmits the password to the biometric recognition lock 12/54 by infrared. In an embodiment, as shown in FIGS. 3, 4 and 6, 7, the infrared emitter 46 of the key 14/56 is aligned with the infrared emitter 40 of the biometric recognition lock 12/54, and the user presses the button 44 of the key 14/56 to trigger the infrared emitter 46 to transmit the password to the biometric recognition lock 12/54. Preferably, for example, in the situation where the password is generated by the key 56, triggering the key 56 to generate the password (step 82), generate an indicative signal, for example, a light signal generated from the indicator lamp 70 shown in FIGS. 6-8 and flashing at a frequency, in response to generation of the password by the key 56, and stop generating the indicative signal, for example, the indicator lamp 70 shown in FIGS. 6-8 turns off, after the key 56 has transmitted the password to the biometric recognition lock 12/54 (step 88). Step 90 involves determining whether the password is stored in the biometric recognition lock 12/54, for example, determining whether the password is stored in the storing unit 24 of the biometric recognition lock 12/54. If the determination is affirmative, it means that the key 14/56 matches the biometric recognition lock 12/54 well. In step 92, the password serves as a password for unlocking the biometric recognition lock 12/54, for example, the password Cd1, in subsequent use, is transmitted from the key 14/56 to the biometric recognition lock 12/54, so as to unlock the biometric recognition lock 12/54. Conversely, if the password is not stored in the biometric recognition lock 12/54, it means that the attempt to match the key 14/56 and the biometric recognition lock 12/54 fails, and step 82 through step 90 repeat. In an embodiment, after the password has been stored in the biometric recognition lock 12/54, the biometric recognition lock 12/54 feeds back a completion signal to therefore indicate that the password has been stored in the biometric recognition lock 12/54; hence, by determining whether the completion signal exists during a predetermined time period, it is feasible to determine whether the password is stored in the biometric recognition lock 12/54. Step 90 involves determining whether the completion signal is detected during a predetermined time period, For example, if the completion signal is detected during the predetermined time period, the password is stored in the storing unit 24 of the biometric recognition lock 12/54. Conversely, if the completion signal is not detected during the predetermined time period, the password is not stored in the storing unit 24 of the biometric recognition lock 12/54. Preferably, in the situation where the password is generated by the key 14/56, after the password has been stored in the biometric recognition lock 12/54, the biometric recognition lock 12/54 feeds back the completion signal to the key 14/56 to therefore inform the key 14/56 that the password has been stored in the biometric recognition lock 12/54. If the key 14/56 receives the completion signal during the predetermined time period, the key 14/56 matches the biometric recognition lock 12/54 well. If the key 14/56 does not receive the completion signal during the predetermined time period, the attempt to match the key 14/56 and the biometric recognition lock 12/54 fails, and step 82 is performed, allowing the key 14/56 to generate a new password and performing step 86 through step 90 with the new password.

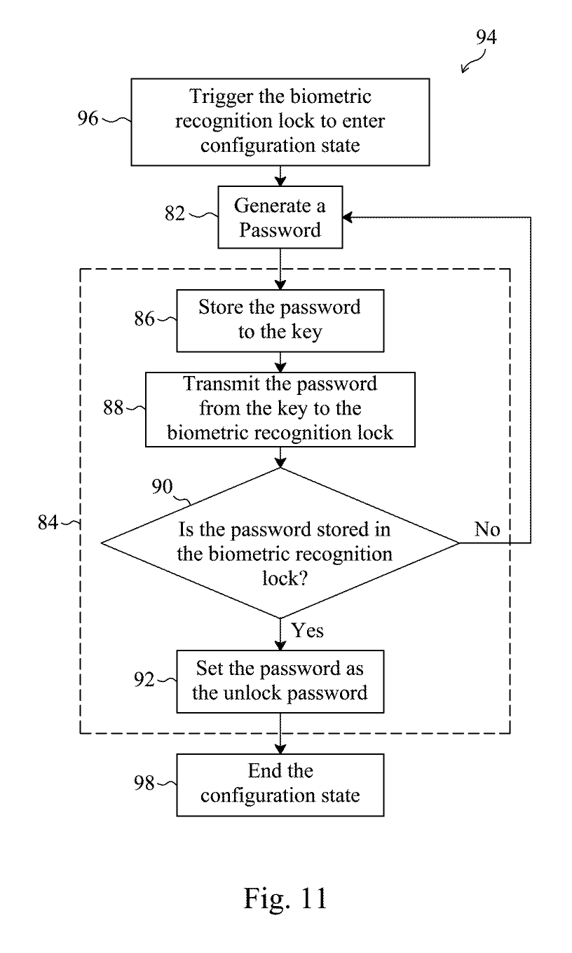

FIG. 11 is another flowchart 94 of a matching method for the biometric recognition lock set 10 according to the present invention. The flowchart 94 comprises step 82 through step 92, step 96 and step 98. Step 82 through step 92 are depicted in FIGS. 9, 10 and thus, for the sake of brevity, are not described herein. Referring to FIGS. 2, 5 and 11, step 96 involves triggering the biometric recognition lock 12/54 to enter the configuration state, for example, pressing the triggering unit 22 in the biometric recognition lock 12/54 continuously for a predetermined time period (for example, three seconds) to trigger the biometric recognition lock 12/54 to enter the configuration state. In an embodiment illustrated by FIG. 3, the button 38 is pressed continuously for the predetermined time period to trigger the biometric recognition lock 12 to enter the configuration state. In another embodiment illustrated by FIG. 4, the hook 50 is at a locked position and is pressed continuously for the predetermined time period to trigger the biometric recognition lock 12 to enter the configuration state. Preferably, the event that the biometric recognition lock 54 enters the configuration state causes the generation of an indicative signal, for example, a light signal generated from the indicator lamp 66 of FIGS. 6, 7 and flashing at a frequency, to indicate that the biometric recognition lock 54 is in the configuration state. In step 98, after the password has been stored in the storing unit 24 of the biometric recognition lock 12/54 to serve as an unlocking password, the configuration state of the biometric recognition lock 12/54 ends. Preferably, termination of the configuration state of the biometric recognition lock 54 is followed by cessation of the generation of the indicative signal, for example, the indicator lamp 66 of FIGS. 6, 7 turns off, to indicate the termination of the configuration state of the biometric recognition lock 54.

Referring to FIGS. 5-7 and 11, in a variant embodiment, for example, in the situation where the password is generated from the key 12/56, in the event of triggering the key 56 to generate the password (step 82), in response to the generation of the password by the key 56 and the generation of a first indicative signal, for example, a light signal generated from the indicator lamp 70 and flashing at a first frequency, as well as the entry of the biometric recognition lock 54 into the configuration state (step 96), generate a second indicative signal, for example, a light signal generated from the indicator lamp 66 and flashing at a second frequency, the first indicative signal and the second indicative signal terminate simultaneously, for example, the indicator lamp 70 and the indicator lamp 66 turn off simultaneously as soon as the user presses the button unit 28 of the key 56 to cause the key 56 to transmit the password to the biometric recognition lock 54, it means that the key 56 matches the biometric recognition lock 54 well. Preferably, the second frequency is different from the first frequency.

What is claimed is:

1. A biometric recognition lock set, comprising
a biometric recognition lock having a first password; and
a key having a second password,
wherein the biometric recognition lock is unlocked upon transmission of the second password from the key to the biometric recognition lock and determination that the second password matches the first password.

2. The biometric recognition lock set of claim 1, wherein the biometric recognition lock comprises:
a body;
a sensing unit disposed on a surface of the body to sense a user's biological information;
a receiving unit disposed on a surface of the body to receive the second password from the key;
a triggering unit disposed on a surface of the body to trigger the biometric recognition lock to enter a configuration state; and
a storing unit connected to the receiving unit to store the second password as the first password when the biometric recognition lock is in the configuration state,
wherein the configuration state ends after the storing unit has stored the second password as the first password.

3. The biometric recognition lock set of claim 2, wherein the sensing unit comprises a fingerprint sensor.

4. The biometric recognition lock set of claim 2, wherein the receiving unit comprises an infrared emitter.

5. The biometric recognition lock set of claim 2, wherein the triggering unit comprises a button, and the biometric recognition lock is triggered to enter the configuration state after the button has been pressed continuously for a predetermined time period.

6. The biometric recognition lock set of claim 2, wherein the biometric recognition lock comprises a biometric recognition padlock with a hook, whereas the triggering unit comprises the hook, such that the biometric recognition lock is triggered to enter the configuration state when the hook is at a locked position and has been pressed continuously for a predetermined time period.

7. The biometric recognition lock set of claim 2, wherein the biometric recognition lock further comprises an indicating unit disposed on a surface of the body to generate an indicative signal when the biometric recognition lock is in the configuration state and stop generating the indicative signal when the configuration state ends.

8. The biometric recognition lock set of claim 7, wherein the indicating unit comprises an indicator lamp, and the indicative signal comprises a light signal generated from the indicator lamp.

9. The biometric recognition lock set of claim 1, wherein the key comprises:
a body;
a button unit disposed on a surface of the body;
a storing unit for storing the second password; and
a transmitting unit connected to the button unit and the storing unit and adapted to transmit the second password to the biometric recognition lock as soon as the button unit is pressed.

10. The biometric recognition lock set of claim 9, wherein the transmitting unit comprises an infrared emitter.

11. The biometric recognition lock set of claim 9, further comprising a controlling unit for generating the second password.

12. The biometric recognition lock set of claim 9, wherein the button unit comprises a button, and the transmitting unit is triggered to transmit the second password as soon as the button is pressed.

13. The biometric recognition lock set of claim 11, wherein the controlling unit is disposed in the key and connected to the button unit and the storing unit to generate and transmit the second password to the storing unit as soon as the button unit is pressed.

14. The biometric recognition lock set of claim 12, wherein the button unit comprises a button, and the controlling unit is triggered to generate and transmit the second password to the storing unit after the button has been pressed continuously for a predetermined time period.

15. The biometric recognition lock set of claim 12, wherein the button unit comprises a first button and a second button, triggering the transmitting unit to transmit the second password when the first button is pressed, and triggering the controlling unit to generate and transmit the second password to the storing unit when the second button is pressed.

16. The biometric recognition lock set of claim 12, wherein the key further comprises an indicating unit disposed on a surface of the body to generate an indicative signal in response to generation of the second password by the controlling unit and, upon transmission of the second password by the transmitting unit, stop generating the indicative signal.

17. The biometric recognition lock set of claim 16, wherein the indicating unit comprises an indicator lamp, and the indicative signal comprises a light signal generated from the indicator lamp.

18. A matching method of a biometric recognition lock set having a biometric recognition lock and a key, the matching method comprising the steps of:
generating a password; and
storing the password in the biometric recognition lock and the key to allow the key to transmit the password to the biometric recognition lock and thereby unlock the biometric recognition lock.

19. The matching method of claim 18, wherein the step of generating the password comprises generating a random number composed of 8-16 digits.

20. The matching method of claim 18, wherein the step of generating the password comprises generating the password by the key.

21. The matching method of claim 20, wherein the step of generating the password comprises triggering the key to generate the password as soon as a button on the key is pressed or has been pressed continuously for a predetermined time period.

22. The matching method of claim 18, wherein the step of generating the password comprises generating the password by a controlling unit.

23. The matching method of claim 18, wherein the step of storing the password in the biometric recognition lock and the key comprises the steps of:
(a) storing the password in the key;
(b) transmitting the password from the key to the biometric recognition lock; and
(c) determining whether the password is stored in the biometric recognition lock, and when the determination is negative, generating a new password, replacing the password with the new password and then repeating the step (a) through the step (c).

24. The matching method of claim 23, wherein the step (b) comprises transmitting the password to the biometric recognition lock as soon as a button on the key is pressed.

25. The matching method of claim 23, wherein the step (b) comprises transmitting the password by infrared.

26. The matching method of claim 23, wherein the step of generating the password comprises generating the password by the key.

27. The matching method of claim 26, further comprising generating an indicative signal upon generation of the password by the key, and ending the indicative signal upon transmission of the password from the key to the biometric recognition lock.

28. The matching method of claim 23, wherein the step (c) comprises determining whether a completion signal fed back by the biometric recognition lock is detected during a predetermined time period, the completion signal indicating that the password has been stored in the biometric recognition lock.

29. The matching method of claim 23, further comprising the steps of:
triggering the biometric recognition lock to enter a configuration state; and
ending the configuration state after the password has been stored in the biometric recognition lock.

30. The matching method of claim 29, wherein, in the step of triggering the biometric recognition lock to enter a configuration state, the biometric recognition lock enters the configuration state after a triggering unit in the biometric recognition lock has been pressed continuously for a predetermined time period.

31. The matching method of claim 29, further comprising the step of generating an indicative signal as soon as the biometric recognition lock enters the configuration state, and ending the indicative signal as soon as the configuration state ends.
